(19) United States
(12) Patent Application Publication
(10) Pub. No.: US 2003/0088330 A1
(43) Pub. Date: May 8, 2003

(54) Method, system and computer program product for coping with the changes in hardware

(75) Inventor: Toshio Ueno, Hanno-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Toshiba Tec Kabushiki Kaisha, Tokyo (JP)

(21) Appl. No.: 10/002,772

(22) Filed: Nov. 2, 2001

(51) Int. Cl. G06F 19/00

(52) U.S. Cl. 700/97; 709/217

(57) ABSTRACT

A method coping a change in hardware accesses a product of a user through a network and acquires information on the product of the user. It further acquires information on a part to be changed, and generates information on a product that requires change of a part from the acquired information on the product of the user and information on the part to be changed.

### BACKGROUND OF THE INVENTION

1. Field of the Invention

The present invention relates to a method, system and computer program product coping with a change in hardware utilizing remote maintenance management.

2. Description of the Related Art

To improve the efficiency of maintenance services, a remote maintenance system has been constructed, in which a user product and a server of a maintenance center are connected via a network and the product is subjected to suitable maintenance by remote control from the maintenance center.

In such a system, a user product to be subjected to maintenance, incorporating a communication device such as a modem, is connected to a server of a maintenance center through a network, for example, the Internet or a private line. With use of this maintenance system, trouble in software of the user product can be eliminated and software can be upgraded by remote control from the server of the maintenance center.

However, if trouble occurs in hardware of the product, it is necessary for a serviceman to check the product, and replace parts or adjust the hardware. If trouble occurs in a product and it results from a particular part, similar trouble may occur in another user's product which is the same type. In this case, the part of the other user's product must also be replaced. Even if trouble does not occur in a product, the particular part may have to be changed in order to improve the quality of the product.

Conventionally, if it is necessary to replace a part as mentioned above, the maintenance center sends instructions for replacement of the part to servicemen. Each serviceman must confirm the types of the user's products that he takes charge of, and judge whether they require replacement of parts. Further, after he judges whether replacement of parts is required, he must calculate the number of required replacement parts, and request the maintenance center to supply the required number of parts. The maintenance center must order the parts after receipt of the request of replacement parts from the serviceman. Therefore, it is difficult to grasp the required number of parts and send scheduled orders for replacement parts immediately after the necessity for part replacement is recognized.

Thus, there is a need for a method and system, which specify a user's product that requires part change, and notify a serviceman of the part change by using a network or a remote maintenance system.

There is also a need for a method and system, which calculates the number of parts that require change and orders replacement parts.

### BRIEF SUMMARY OF THE INVENTION

According to an aspect of the present invention, a method coping a change in hardware accesses a product of a user through a network and acquires information on the product of the user, acquires information on a part to be changed, and generates information on a product that requires change of a part from the information on the product of the user and information on the part to be changed.

### BRIEF DESCRIPTION OF THE SEVERAL VIEWS OF THE DRAWING

The accompanying drawings, which are incorporated in and comprise a part of the specification, illustrate presently embodiments of the invention, and together with the general description given above and detailed description of the embodiments given below, serve to explain the principles of the invention.

FIG. 1 is a block diagram for explaining the overall structure of a system according to a first embodiment of the present invention;

FIG. 2 is a structural diagram of a server used in the embodiment;

FIG. 3 is a flowchart showing an operation of coping with a change in hardware in the first embodiment; and

FIG. 4 is a flowchart showing an operation of coping a change in hardware in a second embodiment.

### DETAILED DESCRIPTION OF THE INVENTION

Embodiments of the present invention will now be described with reference to the drawings.

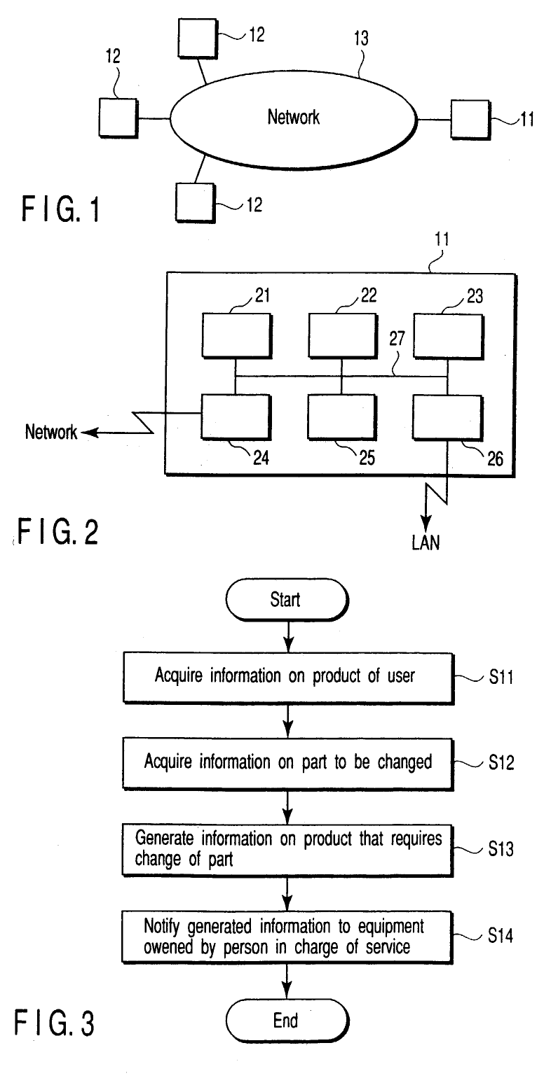

FIG. 1 is a block diagram for explaining the overall structure of a system according to a first embodiment of the present invention. A server 11 of a maintenance center, which exercises control over product maintenance, is connected to each product 12 used by users via a network 13. The network 13 may be a private line managed by the maintenance center and only used by subscribed users. Alternatively, it may be a line that can be used by anybody, such as the Internet.

FIG. 2 is a structural diagram of a server 11 used in the embodiment. The server 11 comprises a CPU 21, a memory 22, an input device 23, a network interface 24, an output device 25, an intracompany LAN interface 26 and a system bus 27.

The memory 22 is a flash memory including a flash memory card drive, a hard disk including a hard disk drive, a ROM, a RAM, or the like. The input device 23 is a keyboard, a mouse, or the like. The network interface 24 is connected to the network server 13, such as the Internet or the private line, i.e., a communication path to the outside of the server 11. The output device 25 is a display or the like. The intracompany LAN interface 26 is connected to another system or a printer in the maintenance center which uses the server 11, or an external system which uses information collected by the server 11. These are connected to one another by the system bus 27.

(First Embodiment)

FIG. 3 is a flowchart showing an operation of coping a change in hardware in the first embodiment. It is premised that the product of the user incorporates a communication device such as a modem, and is connected to the server 11 of the maintenance center via the network 13, such as the Internet or a private line.

In a step S11, the server 11 accesses the product 12 of the user from the network interface 24 through the network 13, and acquires information on the product of the user. The acquisition of the product information is periodically performed. And the server 11 may access the product 12 of the user and acquire product information by necessity. The acquired product information is stored in the memory 11.

The product information includes a product manufacture number, information on an option configuration, network configuration information, usage condition information, software information, etc. It is possible to know the model or version of the product from the product manufacture number. The information on an option configuration is information representing what peripheral equipment is used. The network configuration information is information representing what configuration the network has. The usage condition information includes the number of times of use, the degree of concentration of use, etc., and represents what condition the model is used in. If the product is an image forming apparatus, the usage condition information includes count data of printing and copying. The software information represents information on the software of the product. It includes version information or the like of the software. If the product is an image forming apparatus, the software information includes version information or the like of the printer driver. When the software is changed, the version of the software may be incompatible with a part of the user's product. In this case, it is necessary to not only upgrade the software but also change the part in use. The product information may include user information, such as the address of the user who uses the product, service information on, for example, the service center and serviceman that take charge of the user.

In a step S12, the server 11 acquires hardware change information, i.e., information on a part to be changed. The information includes information on the part to be changed and information of the model to be changed in which the part is incorporated. The information may be acquired by input through the input device 23 of the server 11, or externally acquired through the intracompany LAN interface 26 as data from the outside of the server 11. When the maintenance center or the design department determines that a specific part of a specific model is required, information on the part to be changed is input to the server 11. The information on the part to be changed may include solution information. The solution information is information informing what solution should be taken when trouble occurs in the hardware of the product. In this embodiment, the solution information includes the nature of trouble, the object model, the version of the model, the part to be changed, etc.

The step 11 and the step 12 may be performed in the reverse order. In this case, the server 11 will acquire the information on the product of the user, after acquiring the information on the part to be changed.

In a step S13, the CPU 21 of the server 11 reads the information on the product of the user from the memory 22, performs matching with the information on the part to be changed acquired in the step S12, and generates information on the product that requires change of the part. The information may further include information on the part that needs to be changed, user information and service information.

In a step S14, the information generated in the step 13 is notified to the service center or the equipment owned by the serviceman, i.e., the person in charge of the service. The information may be notified as data to the equipment owned by the person in charge of the service through the intracompany LAN interface 26 of the server 11, or output to the output device 25 of the server 11. Alternatively, it may be output to another printer. In addition to the information generated in the step 13, the solution information may be notified to the equipment owned by the person in charge of the service.

(Second Embodiment)

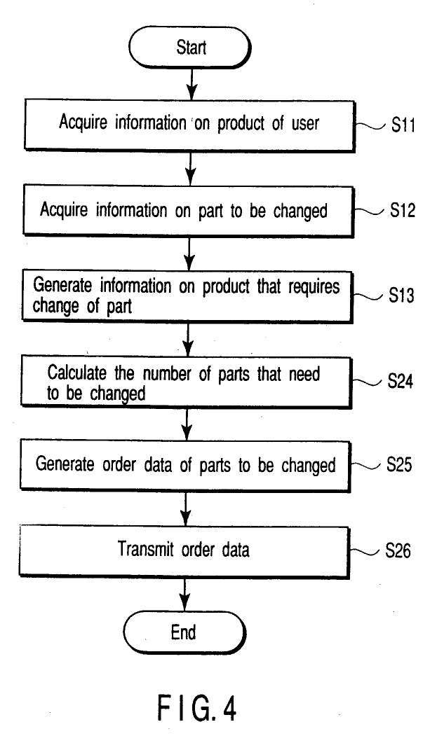

This embodiment is a modification of the first embodiment. FIG. 4 is a flowchart showing an operation of coping a change in hardware of this embodiment. The same symbols as those used in FIG. 3 are assigned to the portions in common with the first embodiment. Detailed descriptions of the step S11 to the step S13, which are in common with the first embodiment, will be omitted.

In a step S24, the total number of parts that need to be changed is calculated from the information on the product that requires change of parts.

In a step S25, order data on the parts to be changed is generated from the calculated numbers of the parts that need to be changed. The order data includes the part name and the part number that specify the part, and the number of each part required. The order data serves as basic data for a written order.

In a step S26, the generated order data is transmitted to a service parts system. The order data may be transmitted to a parts department or a parts maker. Alternatively, the generated order data may be output to the printer so that it can be transmitted to the parts department.

FIGS. 3 and 4 are flowchart illustrations of the method and the system according to the embodiments of the invention. Each block of the flowchart and combinations of blocks in the flowchart can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block or blocks. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the function specified in the flowchart block or blocks.

An optical disk such as a CD-ROM, a magneto-optical disk such as an MO, or a semiconductor memory may be a concrete example of the computer-readable memory.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A method coping a change in hardware comprising:
accessing a product of a user through a network and acquiring information on the product of the user;
acquiring information on a part to be changed; and
generating information on a product that requires change of a part, from the information on the product of the user and the information on the part to be changed.

2. The method according to claim 1, further comprising:
notifying the information on the product that requires change of the part to an equipment owned by a person in charge of service.

3. The method according to claim 1, further comprising:
calculating a number of parts to be,changed based on the information on the product that requires change of the part.

4. The method according to claim 3, further comprising:
generating order data on the part to be changed from the calculated number of parts to be changed.

5. The method according to claim 4, further comprising:
transmitting the order data to a service parts system.

6. The method according to claim 2, wherein the acquired information on the part to be changed includes solution information, and the solution information is notified to the equipment owned by the person in charge of service along with the information on the product that requires change of the part.

7. The method according to claim 1, wherein the information on the product of the user includes a product manufacture number.

8. The method according to claim 1, wherein the information on the product of the user includes information on an option configuration.

9. The method according to claim 1, wherein the information on the product of the user includes information on a network configuration.

10. The method according to claim 1, wherein the information on the product of the user includes usage condition information.

11. The method according to claim 1, wherein the information on the product of the user includes software information.

12. A system coping a change in hardware comprising:
a product information acquiring section which accesses a product of a user through a network and acquires information on the product of the user;
a change information acquiring section which acquires information on a part to be changed; and
an information generating section which generates information on a product that requires change of a part from the information on the product of the user and the information on the part to be changed.

13. The system according to claim 12, further comprising:
a notifying section which notifies the information on the product that requires change of the part to an equipment owned by a person in charge of service.

14. The system according to claim 12, further comprising:
a calculating section which calculates a number of parts to be changed based on the information on the product that requires change of the part.

15. The system according to claim 14, further comprising:
an order data generating section which generates order data on the part to be changed from the calculated number of parts to be changed.

16. The system according to claim 15, further comprising:
a transmitting section which transmits the generated order data to a service parts system.

17. The system according to claim 13, wherein the acquired information on the part to be changed includes solution information, and the solution information is notified to the equipment owned by the person in charge of service along with the information on the product that requires change of the part.

18. The system according to claim 12, wherein the information on the product of the user includes a product manufacture number.

19. The system according to claim 12, wherein the information on the product of the user includes information on an option configuration.

20. The system according to claim 12, wherein the information on the product of the user includes software information.

21. The system according to claim 12, wherein the information on the product of the user includes usage condition information.

22. A computer program product for coping a change in hardware, comprising: a computer-readable storage medium having computer-readable program code means embodied in said medium, said computer-readable program code means comprising:
computer readable program code means for accessing a product of a user through a network and acquiring information on the product of the user;
computer readable program code means for acquiring information on a part to be changed; and
computer readable program code means for generating information on a product that requires change of a part from the information on the product of the user and the information on the part to be changed.

23. The computer program product according to claim 22, wherein said computer-readable program code means further comprising:
computer readable program code means for notifying the information on the product that requires change of the part to an equipment owned by a person in charge of service.

24. The computer program product according to claim 22, wherein said computer-readable program code means further comprising:
computer readable program code means for calculating a number of parts to be changed based on the information on the product that requires change of the part.

25. The computer program product according to claim 24, wherein said computer-readable program code means further comprising:
computer readable program code means for generating order data on the part to be changed from the calculated number of parts to be changed.

26. The computer program product according to claim 25, wherein said computer-readable program code means further comprising:
computer readable program code means for transmitting the order data to a service parts system.

27. The computer program product according to claim 23, wherein the acquired information on the part to be changed includes solution information, and the solution information is notified to the equipment owned by the person in charge of service along with the information on the product that requires change of the part.

28. The computer program product according to claim 22, wherein the information on the product of the user includes a product manufacture number.

29. The computer program product according to claim 22, wherein the information on the product of the user includes usage condition information.

30. The computer program product according to claim 22, wherein the information on the product of the user includes software information.

31. The method according to claim 11, wherein the software information is software version information.

32. The system according to claim 20, wherein the software information is software version information.

33. The computer program product according to claim 30, wherein the software information is software version information.
